(19) United States
(12) Patent Application Publication
(10) Pub. No.: US 2007/0265381 A1
(43) Pub. Date: Nov. 15, 2007

(54) Thermoplastic Resin Composition and Optical Element Utilizing the Same

(76) Inventor: Masako Kikuchi, Higashimurayama-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/666,026

(22) PCT Filed: Oct. 20, 2005
(86) PCT No.: PCT/JP05/19301

§ 371 Date: Apr. 23, 2007

(30) Foreign Application Priority Data
Nov. 2, 2004 (JP) 2004-318878

(51) Int. Cl. C08L 101/00; C08K 3/00; G02B 1/04

(52) U.S. Cl. 524/428

(57) ABSTRACT

A thermoplastic resin composition comprising a thermoplastic resin and inorganic particles dispersed in the thermoplastic resin, the thermoplastic resin being melt-moldable, wherein n_{d} and v_{d} of the thermoplastic resin composition satisfy Formula (1), provided that n_{d} represents a refractive index measured at a wavelength of 588 nm and v_{d} represents an Abbe's number:
n_{d}>1.82−0.0042v_{d} Formula (1)

### FIELD OF THE INVENTION

The present invention relates to a thermoplastic resin composition and an optical element utilizing the same, which are suitably utilized as such as a lens, a filter, a grating, an optical fiber and a flat plate optical wave guide, and are provided with a high refractive index, a low dispersion (a high Abbe's number) and excellent transparency and weight reduction adaptability.

### BACKGROUND OF THE INVENTION

In recent years, extensive studies on optoelectronics technologies for a highly information oriented society have been made, and studies on optical materials also have been made to realize said technologies. Optical materials, which support various developments of optoelectronics such as optical telecommunication, optical recording, optical processing, optical measurement and optical calculation, require the following characteristics. That is, such as a high refractive property, low dispersion (that is, a high Abbe's number), heat resistance, transparency, colorless, cleanliness, an easy molding property, a weight reduction adaptability and resistance against chemicals-solvents are required.

Optical materials applied heretofore have been primarily inorganic materials such as quartz and optical glass. Although these inorganic materials have excellent optical characteristics and heat resistance, there are problems of such as processing properties, cost and high density. For example, the density of optical glass having a refractive index of 1.70 is very large to be approximately 3.0 g/cm³. To overcome these problems, in recent years, development of materials, which are provided with excellent optical characteristics in addition to such as processing properties and a weigh reduction capability, has been made, and expectation for organic optical materials particularly resin materials having a thermoplastic property is increasing. Since resin materials having a thermoplastic property is provided with many merits such as weight reduction adaptability, excellent flexibility, no dielectric loss and easy mold processing, developments for applications to an optical fiber, a wave guide, an optical disc substrate, an optical filter, a lens and an adhesive for optics, have been promoted.

The typical thermoplastic resin material includes polycarbonate resin, and among them, those a starting material of which is 2,2-bis(4-hydroxyphenyl)propane (generally called as bisphenol A) have been studied to be applied to optical parts in various fields because of the merits such as excellent transparency, being lighter than glass, excellent impact resistance and capability of being melt molded as well as capability of big scale production. However, although the resin is provided with a relatively high refractive index of approximately 1.58, an Abbe's number indicating dispersion of refractive index is as low as 30 resulting in bad balance between refractive index and dispersion, and, presently, the application is limited as a resin to constitute optical parts.

For example, it is known that a raw material for a lens for eyewear as typical optical parts preferably requires an Abbe's number of not less than 40 in consideration of a visual function (for example, refer to non-patent literature 1), however, it is difficult to achieve desired characteristics with a polycarbonate resin employing bisphenol A without modification.

Although many attempts have been made to overcome these problems, in the case of an application to a lens for eyewear, there are few types of resin having an Abbe's number of not less than 40 which is expected in view of a visual function and most of the types have an Abbe's number of approximately 30-38. Further, some types of resin provided with an Abbe's number of not less than 40 have been proposed; however, the refractive index is at most approximately 1.56 which is not acceptable in applications requiring a high refractive index and a high Abbe's number. For example, as for a lens for eyewear, a refractive index of not less than 1.58 is expected while having an Abbe's number of not less than 40.

Further, for example, as for such as an optical fiber, an optical wave guide and some lenses, also desired is development of combination use of plural materials having different refractive indexes and of a material having a distribution of the refractive index. To obtain these materials, it is indispensable to be able to arbitrarily control the refractive index.

On the other hand, particularly, development of a thermoplastic resin aiming to a lens for eyewear has been extensively performed. Many types of resins have been commercialized so far, and most of them have both of a high refractive index of not less than 1.60 and an Abbe's number of not less than 40, exhibit excellent optical characteristics, and are lighter in weight compared to the optical glass which has been mainly used heretofore (for example, refer to non-patent literature 1). However, since these resins are thermocurable resins, manufacturing thereof generally requires complicated processes and a long time of not less than some tens hours, which has been a big problem with respect to manufacturing efficiency.

Therefore, a thermoplastic material and optical parts constituted by using the same, which are provided with all of a high refractive index, a low refractive index dispersion (a high Abbe's number), heat resistance, transparency and weight reduction adaptability, as well as are capable of arbitrarily controlling the refractive index, have not yet been found and development thereof has been strongly desired.

In view of the above-described demand, a method to utilize a particle filler has been proposed as one of the methods to control refractive index of an organic optical material such as a plastic lens.

This particle filler is utilized to correct a refractive index of an organic optical material; and by employing a filler having a sufficiently small particle diameter, the plastic material containing the filler can maintain sufficient transparency as an optical element without causing optical scattering by the filler.

For example, as a method to provide an optical element made of organic polymer which can achieve a high refractive index, a method to uniformly disperse particles having a high refractive index and a high Abbe's number in base material polymer (for example, refer to patent literature 1). Further, as a method to provide an optical material having a high refractive index and a low refractive index dispersion, proposed has been a material composition comprising thermoplastic resin and titanium oxide particles (for example, refer to patent literatures 2 and 3). However, with the methods described in patent literatures 2 and 3, sufficiently low refractive index dispersion cannot be achieved because of incorporation of particles having a high refractive index and a low Abbe's number such as titanium oxide to obtain a high refractive index. Further, even when particles having a high refractive index and a high Abbe's number described in patent literature 1 are used, a polymer having a sufficiently high refractive index cannot be prepared or extremely large amount of particles have to be incorporated, and, in either case, the demand expected for an optical lens cannot been satisfied.

[Patent literature 1] JP-A 2001-183501 (claims) (Herein after, JP-A refers to Japanese Patent Application Publication No.)

[Patent literature 2] JP-A 2003-73559 (claims)

[Patent literature 3] JP-A 2003-73564 (claims)

[Non-patent literature 1] “Kikan Kagaku Sousetsu, No. 39, Control of Refractive Index of Transparent Polymer”, edited by The Chemical Society of Japan, Japan Scientific Societies Press.

### SUMMARY OF THE INVENTION

An object of this invention is to provide a thermoplastic resin composition and an optical element utilizing the same which have a high refractive index, a low refractive index dispersion (a high Abbe's number) and are excellent in transparency and weight reduction adaptability.

An embodiment to achieve the above object of this invention is a thermoplastic resin composition comprising a thermoplastic resin and inorganic particles dispersed in the thermoplastic resin, the thermoplastic resin being melt-moldable, wherein n_{d} and v_{d} of the thermoplastic resin composition satisfy Formula (1), provided that n_{d} represents a refractive index measured at a wavelength of 588 nm and v_{d} represents an Abbe's number:
n_{d}>1.82−0.0042v_{d} Formula (1)

### BRIEF DESCRIPTION OF THE DRAWINGS

FIG. 1 is a schematic drawing to show an example of a pickup apparatus for an optical disc in which an optical element (an optical resin lens) of this invention is applied as an objective lens.

### DESCRIPTION OF THE PREFERRED EMBODIMENTS

The above-described object of this invention will be achieved by the following structures.

(1) A thermoplastic resin composition comprising a thermoplastic resin and inorganic particles dispersed in the thermoplastic resin, the thermoplastic resin being melt-moldable, wherein n_{d} and v_{d} of the thermoplastic resin composition satisfy Formula (1), provided that n_{d} represents a refractive index measured at a wavelength of 588 nm and v_{d} represents an Abbe's number:
n_{d}>1.82−0.0042v_{d} Formula (1)
(2) The thermoplastic resin composition of Item (1), wherein the Abbe's number v_{d} is 40 to 70.
(3) A thermoplastic resin composition comprising a thermoplastic resin having a refractive index n₀ measured at a wavelength of 588 nm and inorganic particles dispersed in the thermoplastic resin, the thermoplastic resin being melt-moldable, wherein f, n_{d} and v_{d} of the thermoplastic resin composition satisfy Formulas (2) and (3), provided that f represents a volume fraction of the inorganic particles based on the volume of the thermoplastic resin composition, n_{d} represents a refractive index measured at a wavelength of 588 nm and v_{d} represents an Abbe's number:
n_{d}≧n₀+0.3f Formula (2)
v_{d}≧50 Formula (3)
(4) The thermoplastic resin composition of Item (3), wherein f is not more than 0.3.
(5) The thermoplastic resin composition of Item (3) or (4), wherein n_{d} measured at a wavelength of 588 nm is not less than 1.6.
(6) The thermoplastic resin composition of any one of Items (1) to (5), wherein the inorganic particles comprise at least aluminum nitride.
(7) A thermoplastic resin composition comprising a thermoplastic resin and inorganic particles dispersed in the thermoplastic resin, the thermoplastic resin being melt-moldable, wherein, the inorganic particles comprise at least a metal nitride.
(8) The thermoplastic resin composition of Item (7), wherein the metal nitride is aluminum nitride.
(9) An optical element formed by molding the thermoplastic resin composition of any one of Items (1) to (8), wherein a mean light transmittance measured at a wavelength of 588 nm per a light path length of 3 mm is not less than 70%.

In the following, the most preferable embodiment to practice this invention will be detailed.

The inventor of this invention, as a result of extensive studies in view of the above-described problems, has found that the above objective effects of this invention can be achieved by the following structures: 1) A thermoplastic resin composition in which inorganic particles are dispersed and which is capable of being melt molded, wherein a condition defined by aforesaid Formula (1) is satisfied when a refractive index against light having a wavelength of 588 nm is n_{d} and an Abbe's number is v_{d}; 2) A thermoplastic resin composition in which inorganic particles are dispersed in a thermoplastic resin having a refractive index against light having a wavelength of 588 nm is n₀ and which is capable of being melt molded, wherein the conditions defined by aforesaid Formulas (2) and (3) are simultaneously satisfied when a volume fraction of said inorganic particles is f, a refractive index against light having a wavelength of 588 nm is n_{d} and an Abbe's number is v_{d}; or 3) A thermoplastic resin composition in which inorganic particles are dispersed and which is capable of being melt molded, wherein at least one type of the aforesaid inorganic particles is a metal nitride.

In the following, details of this invention will be explained.

A thermoplastic resin composition of this invention, in which inorganic particles are dispersed and which is capable of being melt molded, is characterized in that following Formula (1) is satisfied when a refractive index against light having a wavelength of 588 nm is n_{d} and an Abbe's number is v_{d}.
n_{d}>1.82−0.0042v_{d}. Formula (1)

Abbe's number v_{d} referred in this invention is defined by following Formula (4), when refractive indexes at 588 nm, 486 nm and 656 nm each are n_{d}, n_{F} and n_{C}, respectively.
v_{d}=(n_{d}−1)/(n_{F}−n_{C}) Formula (4)

In this invention, the Abbe's number of a thermoplastic resin composition of this invention is preferably not less than 40 and not more than 70.

In this invention, refractive indexes at 588 nm, 486 nm and 656 nm can be measured by use of a refractometer well known in the art, and can be determined by use of such as Abbe's Refractometer DR-M2 (produced by Atago Co., Ltd.) and Automatic Birefringence Analyzer KOBRA-21ADH (produced by Oji Instrument Co., Ltd.).

A thermoplastic resin composition having a high refractive index, a low dispersion (a high Abbe's number) in addition to excellent transparency can be obtained by that refractive index n_{d} and Abbe's number v_{d} of the thermoplastic resin composition satisfy a condition defined by aforesaid Formula (1).

In this invention, a means to satisfy a condition defined by aforesaid Formula (1) can be achieved by, for example, appropriate selection of thermoplastic resin provided with a specific refractive index and Abbe's number as described in Table 1, which will be described later; appropriate selection of a type and a volume fraction of inorganic particles to be dispersed; or an appropriate combination thereof.

Further, a thermoplastic resin composition of this invention, in which inorganic particles are dispersed and which is capable of being melt molded, is characterized by that inorganic particles are dispersed in thermoplastic resin having a refractive index against light having a wavelength of 588 nm is n₀, wherein the conditions defined by following Formulas (2) and (3) are simultaneously satisfied when a volume fraction of said inorganic particles is f and an Abbe's number is v_{d}.

Herein, volume fraction f of inorganic particles against a thermoplastic resin composition is defined by f=(total volume of inorganic particles in thermoplastic resin composition)/(volume of thermoplastic resin composition).

In aforesaid Formula (2), 0.3 which is a coefficient of volume fraction f is an inclination (a rate of change) of refractive index n_{d} against volume fraction f of inorganic particles, and an object of this invention can be achieved when this inclination is not less than 0.3, preferably not less than 0.4 and furthermore preferably not less than 0.5.

When this inclination is larger, a higher refractive index of the thermoplastic resin composition is obtained with a low volume fraction f of inorganic particles, and further, possible is compatibility of a high refractive index and a low dispersion when the Abbe's number is 50 or more.

Volume fraction f of inorganic particles is preferably not more than, 0.3 more preferably not more than 0.2 and further more preferably not more than 0.1. When it is over 0.3, addition into thermoplastic resin becomes difficult, the thermoplastic resin composition becomes hard to make kneading and molding difficult, and there may arise a problem of increasing density of the thermoplastic resin composition.

Next, details of a thermoplastic resin composition of this invention will be explained.

First, inorganic particles according to this invention will be explained.

In a thermoplastic resin composition of this invention, inorganic particles are not specifically limited; however, one of the characteristics is incorporation of metal nitride, with respect to sufficient exhibition of the above-described object of this invention.

A metal element preferably utilized in this invention is not specifically limited provided being metal capable of being nitrogenated and includes such as aluminum, titanium, iron, silicon, boron, gallium, niobium, zirconium and chromium. One type of these metal nitrides may be utilized alone or plural types may be utilized in combination. In this invention, among metal nitrides, aluminum nitride is particularly preferably utilized. As particles of aluminum nitride applicable in this invention, for example, those having a mean particle diameter of 5-25 μm are manufactured by means of a plasma synthesis and available from Nanomat Inc. as well as a manufacturing method thereof is described in such as JP-A 2001-206708, however, in this invention, such as the manufacturing method is not limited thereto.

As inorganic particles utilized in this invention, the above-descried metal nitride is preferably utilized, however, they are not limited thereto and inorganic particles well known in the art such as oxide particles can be also utilized.

Oxide particles utilized in this invention is metal oxide, in which metal to constitute metal oxide is one or not less than two types of metal selected from a group comprising Li, Na, Mg, Al, Si, K, Ca, Sc, Ti, V, Cr, Mn, Fe, Co, Ni, Cu, Zn, Rb, Sr, Y, Nb, Zr, Mo, Ag, Cd, In, Sn, Sb, Cs, Ba, La, Ta, Hf, W, Ir, Tl, Pb, Bi and rare earth metals; and specifically can be appropriately selected among such as silicon oxide, titanium oxide, zinc oxide, aluminum oxide, zirconium oxide, hafnium oxide, niobium oxide, tantalum oxide, magnesium oxide, calcium oxide, strontium oxide, barium oxide, indium oxide, tin oxide and lead oxide; a double oxide comprising them such as lithium niobate, potassium niobate, lithium tantalate, aluminum-magnesium oxide (MgAl₂O₄). Further, oxide particles utilized in this invention may be rare earth oxide and specifically include such as scandium oxide, yttrium oxide, lanthanum oxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide and lutetium oxide. As metal salt particles, such as carbonate, phosphate and sulfate can be appropriately utilized.

Further, in this invention, semiconductor particles can be utilized, and semiconductor particles in this invention mean particles having a semiconductor crystal composition. As specific composition examples of said semiconductor crystal composition includes a simple substance of a group 14 element of the periodic table such as carbon, silicon, germanium and tin; a simple substance of a group 15 element of the periodic table such as phosphor (black phosphor), a simple substance of a group 16 element of the periodic table such as selenium and tellurium; a compound comprising plural group 14 elements of the periodic table such as silicon carbide (SiC); a compound comprising a group 14 element of the periodic table and a group 16 element of the periodic table such as tin (IV) oxide (SnO₂), tin (II, IV) sulfide (Sn(II)Sn(IV)S₃), tin (II) sulfide (SnS₂), tin (II) selenide (SnSe), tin (II) telluride (SnTe), lead (II) sulfide (PbS), lead (II) selenide (PbSe), lead (II) telluride (PbTe); a compound comprising a group 13 element of the periodic table and a group 15 element of the periodic table (or a III-V group compound semiconductor), such as boron nitride (BN), boron phosphide (BP), boron arsenide (BAs), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaAs), indium nitride (InN), indium phosphide (InP), indium arsenide (InAs) and indium antimonide (InSb); a compound comprising a group 13 element of the periodic table and a group 16 element of the periodic table such as aluminum sulfide (Al₂S₃), aluminum selenide (Al₂Se₃), gallium sulfide (Ga₂S₃), gallium selenide (Al₂Se₃), gallium telluride (Ga₂Te₃), indium oxide (In₂O₃), indium sulfide (In₂S₃), indium selenide (In₂Se₃) and indium telluride (In₂Te₃); a compound comprising a group 13 element of the periodic table and a group 17 element of the periodic table such as thallium (I) chloride (TlCl), thallium (I) bromide (TlBr) and thallium (I) iodide (TlI); a group 12 element of the periodic table and a group 16 element of the periodic table (or II-VI group compound semiconductor) such as zinc oxide (ZnO), zinc sulfide (SnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe) and mercury telluride (HgTe); a compound comprising a group 15 element of the periodic table and a group 16 element of the periodic table such as arsenic (III) sulfide (As₂S₃), arsenic (III) selenide (As₂Se₃), arsenic (III) telluride (As₂Te₃), antimony (III) sulfide (Sb₂S₃), antimony (III) selenide (Sb₂Se₃), antimony (III) telluride (Sb₂Te₃), bismuth (III) sulfide (Bi₂S₃), bismuth (III) selenide (Bi₂Se₃) and bismuth (III) telluride (Bi₂Te₃); a compound comprising a group 11 element of the periodic table and a group 16 element of the periodic table such as cuprous (I) oxide (Cu₂O) and cuprous (I) selenide (Cu₂Se); a compound comprising a group 11 element of the periodic table and a group 17 element of the periodic table such as cuprous (I) chloride (Cu₂Cl), cuprous (I) bromide (Cu₂Br), cuprous (I) iodide (Cu₂I), silver chloride (AgCl) and silver bromide (AgBr); a compound comprising a group 10 element of the periodic table and a group 16 element of the periodic table such as nickel (II) oxide (NiO); a compound comprising a group 9 element of the periodic table and a group 16 element of the periodic table such as cobalt (II) oxide (CoO) and cobalt (II) sulfide (CoS); a compound comprising a group 8 element of the periodic table and a group 16 element of the periodic table such as tri-ion tetroxide (Fe₃O₄) and iron (II) sulfide (FeS); a compound comprising a group 7 element of the periodic table and a group 16 element of the periodic table such as manganese (II) oxide (MnO); a compound comprising a group 6 element of the periodic table and a group 16 element of the periodic table such as molybdenum (IV) sulfide (MoS₂) and tungsten (IV) oxide (WO₂); a compound comprising a group 5 element of the periodic table and a group 16 element of the periodic table such as vanadium (II) oxide (VO), vanadium (IV) oxide (VO₂) and tantalum (V) oxide (Ta₂O₅); a compound comprising a group 4 element of the periodic table and a group 16 element of the periodic table such as titanium oxide (such as TiO₂, Ti₂O₅, Ti₂O₃ and Ti₅O₉); a compound comprising a group 2 element of the periodic table and a group 16 element of the periodic table such as magnesium sulfide (MgS) and magnesium selenide (MgSe); calcogen spinels such as cadmium (II) chromium (III) oxide (CdCr₂O₄), cadmium (II) chromium (III) selenide (CdCr₂Se₄), copper (II) chromium (III) sulfide (CdCr₂S₄) and mercury (II) chromium (III) selenide (HgCr₂Se₄); and barium titanate (BaTiO₃). Herein, a semiconductor cluster the structure of which is determined such as (BN)₇₅(BF₂)₁₅F₁₅, reported in Adv. Mater., vol. 4, p. 494 (1991) by G. Schmid et al, and Cu₁₄₆Se₇₃(triethylphosphine)₂₂, reported in Angew. Chem. Int. Ed. Engl., vol. 29, p. 1452 (1990) by D. Fenske et al, is also listed as an example.

As the above-described particles, one type of inorganic particles may be utilized alone or plural types of inorganic particles may be utilized in combination. By employing plural types of particles having different properties, it is also possible to further efficiently improve the required characteristics.

Further, the mean particle diameter of inorganic particles according to this invention is preferably not less than 1 nm and not more than 30 nm, more preferably not less than 1 nm and not more than 20 nm and furthermore preferably not less than 1 nm and not more than 10 nm. Since dispersion of inorganic particles may become difficult not to achieve desired capabilities in the case of a mean particle diameter of less than 1 nm, the mean particle diameter is preferably not less than 1 nm; since prepared thermoplastic material composition may become turbid to decrease the transparency resulting in a light transmittance of less than 70% in the case of a mean particle diameter of over 30 nm, the mean particle diameter is preferably not more than 30 nm. A mean particle diameter referred to here means a volume average value of the converted diameter of each particle which is a diameter of a sphere having the same volume of the particle (the diameter of an equivalent volume sphere) when each particle is converted to a sphere having the same volume.

Further, the form of inorganic particles is not specifically limited; however, particles having a spherical form are preferably utilized. Specifically, the minimum particle diameter (the minimum value of the distance between two lines of tangents which are drawn in contact with the circumference of a particle)/the maximum particle diameter (the maximum value of the distance between two lines of tangents which are drawn in contact with the circumference of a particle), of the particle, is preferably 0.5-1.0 and more preferably 0.7-1.0.

Further, distribution of particle diameter is also not specifically limited; however, those having a relatively narrow distribution rather than those having a broad distribution are preferably utilized.

Further, it is preferable that inorganic particles are subjected to a surface treatment. A method to treat the surface of inorganic particles includes such as a surface treatment by a surface modifier such as a coupling agent, and a surface treatment by polymer graft or mechanochemical.

Further, a surface modifier utilized for a surface treatment of inorganic particles includes silicone oil, coupling agents of a titanate type, an aluminate type and a zirconate type, in addition to a silane type coupling agent. These are not specifically limited, however, can be appropriately selected depending on the type of inorganic particles and thermoplastic resin which disperse the inorganic particles. Further, not less than two of various types of surface treatments can be simultaneously or separately performed.

A silane type surface treating agent includes vinylsilazane trimethylchlorosilane, dimethyldichlorosilane, methyltrichlorosilane, trimethylalkoxysilane, dimethyldialkoxysilane, methyltrialkoxysilane and hexamethylalkoxysilane, and hexamethyldisilazane is suitably utilized because it can broadly cover the surface of particles.

As a silicone oil type surface treating agent, utilized can be straight silicone oil such as dimethylsilicone oil, methylphenylsilicone oil and methylhydrogensilicone oil; and modified silicone oil such as amino modified silicone oil, epoxy modified silicone oil, carboxyl modified silicone oil, carbinol modified silicone oil, methacryl modified silicone oil, mercapto modified silicone oil, phenol modified silicone oil, one terminal reactive modified silicone oil, different functional group modified silicone oil, polyether modified silicone oil, methylstyryl silicone oil, alkyl modified silicone oil, higher fatty acid ester modified silicone oil, hydrophilic specific modified silicone oil, higher alkoxy modified silicone oil, higher fatty acid containing modified silicone oil and fluorine modified silicone oil.

These treating agents may be utilized while being appropriately diluted by such as hexane, toluene, methanol, ethanol, acetone and water.

A surface treatment method by a surface modifier includes a wet heating method, a wet filtering method, a dry stirring method, an integral blend method and a granulating method. In the case of performing a surface modification at a particle diameter of not more than 100 nm, a dry stirring method is preferably employed with respect to restraining of particle coagulation; however, the method is not limited thereto.

These surface modifiers may be utilized alone or in combination of plural types. Further, since characteristics of surface modified particles may differ depending on a utilized surface modifier, it is also possible to improve the affinity for utilized thermoplastic resin, which is employed to prepare a resin composition, by selection of a surface modifier. The ratio of a surface modifier is not specifically limited; however, is preferably within a range of 10-99 weight % and more preferably 30-98 weight %, against particles having been modified.

Next, thermoplastic resin according to this invention will be explained.

Thermoplastic resin utilizable in this invention, in which inorganic particles are dispersed, is not specifically limited provided being a transparent thermoplastic resin generally utilized as an optical material, however, is preferably acrylic resin, cycloolefin resin, polycarbonate resin, polyester resin, polyether resin, polyamide resin or polymide resin, in consideration of processing properties as an optical element, and specifically preferably cycloolefin resin, including, for example, compounds described in JP-A 2003-73559; preferable examples of which will be shown in table 1.

TABLE 1

| | | Refractive | Abbe’s |
|---|---|---|---|
| Resin No. | Structure | index n | number n |
| (1) | 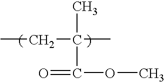 | 1.49 | 58 |
| (2) | 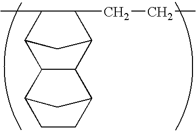 | 1.54 | 56 |
| (3) | 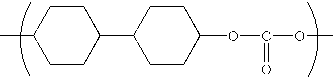 | 1.53 | 57 |
| (4) | 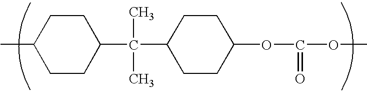 | 1.51 | 58 |
| (5) | 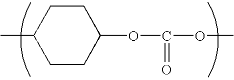 | 1.52 | 57 |
| (6) | 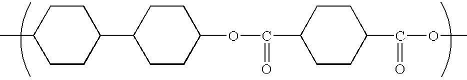 | 1.54 | 55 |
| (7) | 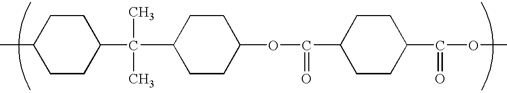 | 1.53 | 57 |
| (8) | 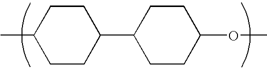 | 1.55 | 57 |
| (9) | 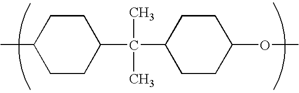 | 1.54 | 57 |
| (10) | 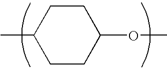 | 1.55 | 58 |
| (11) | 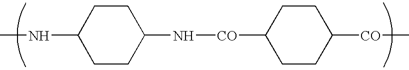 | 1.55 | 53 |
| (12) | 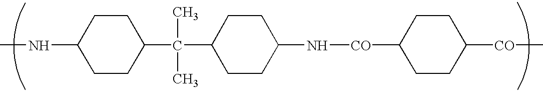 | 1.54 | 55 |
| (13) | 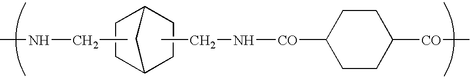 | 1.54 | 56 |
| (14) | 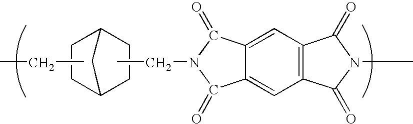 | 1.58 | 43 |

Further, in a thermoplastic resin material according to this invention, the water absorption is preferably not more than 0.2 weight %. Resin having water absorption of not more than 0.2 weight % is preferably, for example, polyolefin resin (such as polyethylene and polypropylene), fluorine resin (such as polytetrafluoroethylene, Teflon™ AF (manufactured by Dupont), Cytop (manufactured by Asahi Glass Co., Ltd.)), cycloolefin resin (such as Zeonex (manufactured by Nippon Zeon Co., Ltd.), Arton (manufactured by JSR Corp.), Apel (manufactured by Mitsui Chemical Co., Ltd.) and Topas (manufactured by Polyplastic Corp.)), indene/styrene type resin and polycarbonate, however, is not limited thereto. Further, it is also preferable to utilize these resins and other resin having compatibility with these resins in combination. In the case of utilizing at least two types of resin, the water absorption is considered to be approximately equal to the average value of water absorption of individual resin, and the average water absorption should be not more than 0.2%.

A thermoplastic resin composition of this invention is primarily constituted of thermoplastic resin and inorganic particles as described above, and the preparation method is not specifically limited. That is, applied can be any method such as a method in which thermoplastic resin and inorganic particles each are independently prepared, which is followed by mixing the both; a method in which thermoplastic resin is prepared under a condition that inorganic particles having been prepared in advance are present; a method in which inorganic particles are prepared under a condition that thermoplastic resin having been prepared in advance is present; and a method in which thermoplastic resin and inorganic particles are simultaneously prepared. Specifically, for example, preferably listed is a method to prepare a thermoplastic resin composition, by mixing two solutions of a solution, in which thermoplastic resin has been dissolved, and a dispersion, in which inorganic particles have been homogeneously dispersed, are homogeneously mixed, and the resulting dispersion is added into a solution having poor solubility against the thermoplastic resin, however, the method is not limited thereto.

In thermoplastic resin composition of this invention, the degree of mixing of thermoplastic resin and inorganic particles is not specifically limited; however, it is preferable to be homogeneously mixed to efficiently exhibit the effect of this invention. In the case of an insufficient degree of mixing, there is a fear that optical characteristics such as refractive index, Abbe's number and light transmittance may be affected in addition that resin processing properties such as a thermoplastic property and a melt molding capability may be badly affected. The degree of mixing is considered to be affected by the preparation method, and it is important to select the method in sufficient consideration of characteristics of thermoplastic resin and inorganic particles which are utilized.

A method in which thermoplastic resin and inorganic particles are directly bonded can be preferably utilized in order to more homogeneously mix the both of thermoplastic resin and inorganic particles.

A thermoplastic resin composition of this invention is an optically excellent resin composition which is provided with a high refractive index and low dispersion (a high Abbe's number) in addition to high transparency, and is a thermoplastic material having a extremely superior mold processing adaptability because being provide with a thermoplastic property and/or an injection molding property. A material provided with the both of excellent optical characteristics and a mold processing adaptability could not be achieved with a material disclosed heretofore, and it is considered that a combination of specific thermoplastic resin and specific inorganic particles contributes these characteristics.

In a preparation process or a molding process of a thermoplastic resin material of this invention, various types of additives (also referred to as compounding ingredients) may be appropriately incorporated. The additive is not specifically limited and includes a stabilizer such as an antioxidant, a heat stabilizer, a light stabilizer, a weather stabilizer, an ultraviolet absorbent and a near infrared absorbent; a resin modifier such as a sliding agent and a plastisizer; an anti milky whitening agent such as a soft polymer and an alcoholic compound; a colorant such as dye and pigment; an antistatic agent, a non-flammable agent and a filler. These compounding ingredients may be utilized alone or in combination of at least two types, and the blending amount is selected within a range not to disturb the effects described in this invention. In this invention, particularly, polymer preferably contains a plastisizer or an antioxidant.

(Plastisizer)

A plastisizer is not specifically limited and includes such as a phosphoric ester type plastisizer, a phthalic ester type plastisizer, a trimellitic ester type plastisizer, a pyromellitic acid type plastisizer, a glycolate type plastisizer, a citric ester type plastisizer, a polyster type plastisizer.

A phosphoric ester type plastisizer includes such as triphenylphosphate, tricresylphosphate, cresyldiphenylphosphate, octyldiphenylphosphate, diphenylbiphenylphosphate, trioctylphosphate and tributylphosphate; a phthalic ester type plastisizer includes such as diethylphthalate, dimethoxyphthalate, dimethylphthalate, dioctylphthalate, dibutylphthalate, di-2-ethylhexylphthalate, butylbenzylphthalate, diphenylphthalate and dicyclohexylphthalate; a trimellitic ester type plastisizer includes such as tributyltrimellitate, triphenyltrimellitate and triethyltrimellitate; a pyromellitic ester type plastisizer includes tetrabutylpyromellitate, tetraphenylpyromellitate and tetraethylpyromellitate; a glycol type plastisizer includes such as triacetin, tributyrin, ethylphthalyl ethylglycolate, methylphthalyl ethylglycolate and butylphthalyl butylglycolate; and a citric ester type plastisizer includes such as triethyl citrate, tri-n-butyl citrate, acetyltriethyl citrate, acetyltri-n-butyl citrate and acetyltri-n-(2-ethylhexyl) citrate.

(Antioxidant)

An antioxidant utilized in this invention will now be explained.

An antioxidant includes a phenol type antioxidant, a phosphor type antioxidant and a sulfur type antioxidant, and among them preferable is a phenol type antioxidant and specifically preferable among them is an alkyl substituted phenol type antioxidant. By blending these antioxidants, it is possible to prevent tinting of a lens and strength decrease due to such as oxidation deterioration at the time of molding. These antioxidants each can be utilized alone or in combination of at least two types. The blending amount will be selected not to disturb the effects of this invention and is preferably 0.001-5 weight parts and more preferably 0.01-1 weight part, against 100 weight part of a thermoplastic resin composition of this invention.

As a phenol type antioxidant, those conventionally well known in the art can be utilized and listed are an acrylate type compound described in JP-A Nos. 63-179953 and 1-168643 such as 2-t-butyl-6-(3-t-butyl-2-hydroxy-5-methylbenzyl)-4-methylphenylacrylate and 2,4-t-amyl-6-(1-(3,5-di-t-amyl-2-hydroxyphenyl)ethyl)phenylacrylate; an alkyl substituted phenol type compound such as octadecyl-3-(3,5-di-t-butyl-4-hydroxyphenyl)propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenylpropionate))methane [that is, pentaerythrimethyl-tetrakis(3-(3,5-di-t-butyl-4-hydroxyphenylpropionate))], triethyleneglycolbis(3-(3-t-butyl-4-hydroxy-5-methylphenyl)propionate); a triazine group containing phenol type compound such as 6-(4-hydroxy-3,5-di-t-butylanilino)-2,4-bisoctylthio-1,3,5-triazine, 4-bisoctylthio-1,3,5-triazine and 2-octylthio-4,6-bis-(3,5-di-t-butyl-4-oxyanilino)-1,3,5-triazine.

A phosphor type antioxidant is not specifically limited provided being those conventionally utilized in a general resin industry, and includes, for example, a monophosphite type compound such as triphenylphosphite, diphenylisodecylphosphite, phenyldiisodecylphosphite, tris(nonylphenyl)phosphite, tris(dinonylphenyl)phosphite, tris(2,4-di-t-butylphenyl)phosphite and 10-(3,5-di-t-butyl-4-hydroxybenzyl)-9,10-dihydro-9-oxa-10-phosphophenanthrene-10-oxide; and a diphosphite type compound such as 4,4′-butylidene-bis(3-methyl-6-t-butylphenyl-di-tridecylphosphite) and 4,4′-isopropylidene-bis(phenyl-di-alkyl(C12-C15)phosphite). Among them, preferable is a monophosphite type compound and specifically preferable are such as tris(nonylphenyl)phosphite, tris(dinonylphenyl)phosphite and tris(2,4-di-t-butylphenyl)phosphite.

A sulfur type antioxidant includes such as dilauryl 3,3-thiodipropyonate, dimyristyl-3,3′-thiodipropionate, distearyl-3,3-thiodipropionate, laurylstearyl-3,3-thiopropionate, pentaerythritol-tetrakis-(β-lauryl-thiopropionate) and 3,9-bis(2-dodecylthioethyl)-2,4,8,10-tetraoxaspiro[5,5]undecane.

(Light Stabilizer)

A light stabilizer utilized in this invention will now be explained.

A light stabilizer includes a benzophenone type light stabilizer, a benzotriazole type light stabilizer and a hindered amine type light stabilizer, however in this invention, a hindered amine type light stabilizer is preferably utilized with respect to such as transparency and anti-tinting property of a lens. Among a hindered amine type light stabilizer (hereinafter, also referred to as a HALS), those having a polystyrene converted Mn, which is measured by GPC employing teterahydrofuran (THF) as a solvent, of 1,000-10,000 are preferable, more preferably of 2,000-5,000 and specifically preferably of 2,800-3,800. When Mn is excessively small, a predetermined amount may not be blended due to evaporation at the time of blending said HALS in thermoplastic resin by heat melt kneading, or processing stability may be decreased to cause such as foams or silver streaks at the time of heat melt molding such as injection molding. Further, in the case that a lens is used for a long period while the lamp is lit, a volatile component will be generated as a gas from a lens. On the contrary, when Mn is excessively large, dispersion adaptability of block copolymer will decrease to decrease transparency of a lens, resulting in decrease of the improvement effect of light stability. Therefore, in this invention, by setting Mn of a HALS within the above-described range, a lens, which is excellent in processing stability, depression of gas generation and transparency, can be prepared.

Specific examples of such a HALS include high molecular weight HALS, in which plural piperidine rings bond via a triazine skeleton, such as N,N′,N″,N′″-tetrakis-[4,6-bis-{butyl-(N-methyl-2,2,6,6-tetramethylpiperidine-4-yl)amino}-triazine-2-yl]-4,7-diazadecane-1,10-diamine, a polycondensate of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-diyl} {(2,2,6,6-tetramethyl-4-piperidyl)imino}hexamethylene{(2,2,6,6-tetramethyl-4-piperidyl)imino}], a polycondensate of 1,6-hexadiamine-N,N′-bis(2,2,6,6-tetramethyl-4-piperidyl) and morpholine-2,4,6-trichloro-1,3,5-triazine; and poly[(6-morpholino-s-triazine-2,4-diyl)(2,2,6,6-tetramethyl-4-piperidyl)imono]; and a high molecular weight HALS, in which piperidine rings bond via a ester bond such as polymer of dimethyl succinate and 4-hydroxy-2,2,6,6-tetramethyl-1-piperidine ethanol, a mixed estrification compound of 1,2,3,4-butane tetracarboxylate, 1,2,2,6,6-pentamethyl-4-piperidinol and 3,9-bis(2-hydroxy-1,1-dimethylethyl)-2,4,8,10-tetraoxaspiro[5,5]undecane.

Among these, preferable are those having Mn of 2,000-5,000 such as a polycondensate of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-diyl} {(2,2,6,6-tetramethyl-4-piperidyl)imino}hexamethylene{(2,2,6,6-tetramethyl-4-piperidyl)imino}], and polymer of dimethyl succinate and 4-hydroxy-2,2,6,6-tetramethyl-1-piperidine ethanol.

The blending amount of the above-described light stabilizer against a thermoplastic resin composition is preferably 0.01-20 weight parts, more preferably 0.02-15 weight parts and specifically preferably 0.05-10 weight parts, against 100 weight parts of the polymer. When the addition amount is excessively small, the effect of light stability improvement cannot be sufficiently obtained and tinting may be caused in the case of a long period of outdoor usage. On the other hand, when the blending amount of a HALS is excessively large, a part of them may be generated as a gas or dispersion adaptability in resin may be deteriorated to decrease transparency of a lens.

Further, by blending a compound, having the lowest glass transition temperature of not higher than 30° C., in a thermoplastic resin composition of this invention, milky whitening under a circumstance of high temperature and high humidity for a long period can be prevented without deteriorating characteristics such as transparency, heat resistance and mechanical strength.

[Preparation Method of Optical Element (Optical Resin Lens)]

Next, a preparation method of an optical resin lens, which is one of an optical element prepared from a thermoplastic resin composition of this invention described above, will be explained.

In a preparation of an optical resin lens according to this invention, first, a resin composition (comprising resin alone or a mixture of resin and an additive) is prepared, and successively, the obtained resin composition is subjected to a molding process.

A molded product of thermoplastic resin material of this invention is prepared by molding of a material to be molded comprising the aforesaid resin composition. A molding method is not specifically limited, however, is preferably a meld molding to obtain a molded product which is excellent in such as low double refraction, mechanical strength and dimensional stability. A melt molding method includes, for example, commercially available press molding, commercially available extrusion molding and commercially available injection molding on the market, however, injection molding is preferred with respect to a molding property and manufacturing efficiency.

The molding condition is appropriately selected depending on an application purpose or a molding method, however, the temperature of a resin composition in injection molding is preferably in a range of 150-400° C., more preferably in a range of 200-350° C. and most preferably in a range of 200-330° C., in order to prevent a shrink mark and strain of a molded product by providing resin with suitable fluidity at the time of molding, and to prevent a silver streak due to thermal decomposition of resin, in addition to effectively prevent a yellowish discoloration of the molded product.

A molded product according to this invention, which can be utilized in a various forms such as a spherical form, a bar form, a plate form, a column form, a cylinder form, a tube form, a fiber form, a film or sheet form, is utilized as an optical resin lens as one of an optical element of this invention and is also suitable as other optical parts, because of being excellent in low double refraction, transparency, mechanical strength, heat resistance and low water absorption.

(Optical Resin Lens)

An optical resin lens according to this invention is prepared by the preparation method described above, and application examples for optical parts are as follows.

For example, an optical lens and an optical prism include image pick lenses of a camera; lenses of such as a microscope, an endoscope and a telescope; an all-optical transmitting lens such as eyeglass lens; a pickup lens for an optical disc such as CD, CD-ROM, WORM (recordable optical disc), MO (rewritable optical disc; optomagnetic disc), MD (mini-disc) and DVD (digital video disc); and a lens in a laser scanning system such as an fθ lens for a laser beam printer and a lens for a sensor; and a prism lens in a finder system of a camera.

An optical disc application includes such as CD, CD-ROM, WORM (recordable optical disc), MO (rewritable optical disc; optomagnetic disc), MD (mini-disc) and DVD (digital video disc). Other optical applications include a light guide of such as a liquid crystal display; optical film such as polarizer film, retardation film and light scattering film; a light diffusion plate; an optical card; and a liquid crystal display element substrate.

Among these, an optical resin lens according to this invention is suitable as a pickup lens and a laser scanning system lens, which require low double refraction, and is most preferably utilized as a pickup lens.

As an example of an application of an optical resin lens according to this invention, an example of an application as an objective lens utilized in a pickup device for an optical disc will be explained referring to FIG. 2.

In this embodiment, “high density optical disc” employing a so-called blue violet laser light source having a utilized wavelength of 405 nm is the target. This optical disc has a protective substrate of 0.1 mm thick and a memory capacity of approximately 30 GB.

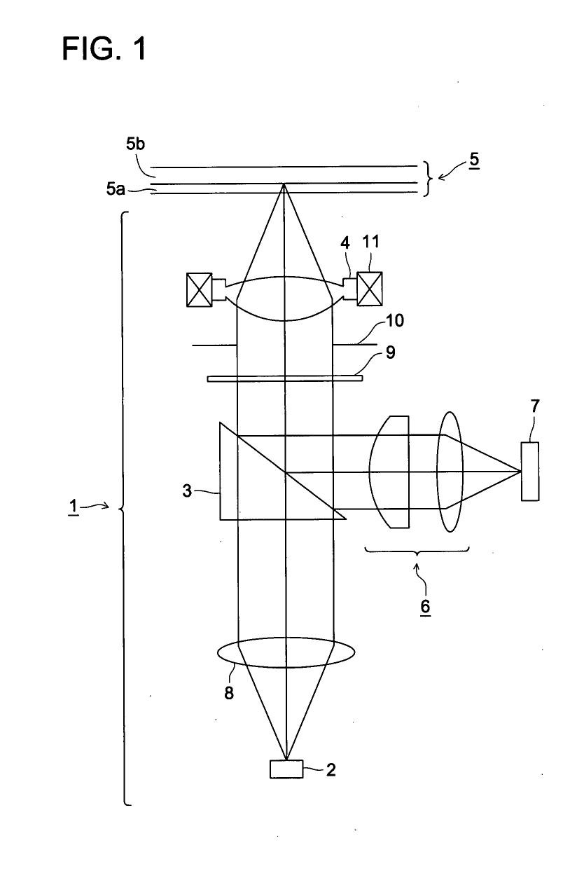

FIG. 1 is a schematic drawing to show an example of a pickup device for an optical disc employing an optical element (an optical resin lens) of this invention as an objective lens.

In optical pickup device 1, laser diode (LD) 2 is a light source and a blue violet laser having wavelength λ of 405 nm is utilized; however, those having a wavelength in a range of 390-420 nm can be appropriately employed.

Beam splitter (BS) 3 transmits the light source being incident from LD2 along the direction of objective optical element (OBL) 4, and is provided with a function to converge the reflection light (the return light) from optical disc (optical information recording medium) 5 on photo receptor (PD) 7 through sensor lens (SL) 6.

The light flux ejected from LD2 is incident on collimator (COL) 8, whereby after having been collimated into infinite parallel light, is incident into objective lens OBL4 through beam splitter (BS) 3. Then, it forms a converged spot on information recording plane 5b via substrate 5a. Successively, after being reflected on information recording surface 5b, the light flux follows the same path and the polarizing direction being changed by ¼ wavelength plate 9 (Q), the light path being bent by BS3, and converged on sensor (PD) 7 through sensor lens (SL) 6. The light flux was subjected to photoelectric conversion to be an electric signal.

Herein, objective optical element OBL4 is a single optical resin lens having been injection molded from resin. And aperture (AP) 10 is provided on the incident plane side to determine the light flux diameter. Herein, the incident light flux is converged to a diameter of 3 mm and is subjected to focusing or trucking by actuator (AC) 11.

Herein, a numerical aperture required for objective optical element OBL4 differs depending on the protective substrate thickness in addition to the size of a bit of an optical information medium. Herein, the numerical aperture of high density optical disc (information recording medium) 5 is set to 0.85.

### EXAMPLES

In the following, this invention will be specifically explained referring to examples, however, this invention is not limited thereto. Herein, in examples, descriptions of “part(s)” or “%” is utilized and represent “weight part(s)” or “weight %”.

<Preparation of Inorganic Particles>

[Preparation of Inorganic Particles A]

Aluminum nitride (a mean particle diameter of approximately 7 nm) of 30 g which had been purchased from Nanomat, Inc. was dispersed in a mixed solution of 300 g methanol and nitric acid aqueous solution of 1 mol %. The resulting solution was added with a mixed solution of 100 g of methanol and 6 g of cyclopentyltrimethoxysilane for over 60 minutes while stirring, followed by being further stirred for 2 hours. The prepared transparent dispersion was suspended in ethylacetate to be subjected to centrifugal separation, whereby inorganic particles A, which are white particles, were prepared.

[Preparation of Inorganic Particles B]

Inorganic particles B were prepared in a similar manner to preparation of inorganic particles A, except that aluminum nitride was changed to aluminum oxide (TM-300, mean particle diameter of 7 nm) manufactured by Taimei Chemicals Co., Ltd.

[Preparation of Inorganic Particles C]

Inorganic particles C were prepared in a similar manner to preparation of inorganic particles A, except that aluminum nitride was changed to titanium oxide (Taipake ST-01, mean particle diameter of 7 nm) manufactured by Ishihara Sangyo Kaisha, Ltd.

<Preparation of Thermoplastic Resin Composition>

<Preparation of Thermoplastic Resin Composition 1>

Into Mixing Kneader Laboplustomill C Type (produced by Toyo Seiki Seisaku-sho, Ltd.) equipped with a mixer (KF70) and a high shear rotor, resin (1) having a refractive index of 1.49 and an Abbe's number of 58, which is described in Table 1, and inorganic particles A prepared above were charged so as to make a weight ratio of 69:31, and the mixture was mixing kneaded at a set temperature of 200° C. and 300 rpm for 5 minutes, whereby thermoplastic resin composition 1 was prepared.

<Preparation of Thermoplastic Resin Composition 2>

Thermoplastic resin composition 2 was prepared in a similar manner to preparation of above-described thermoplastic resin composition 1, except that resin (2) having a refractive index of 1.54 and an Abbe's number of 56, which is described in Table 1, was utilized instead of resin (1).

<Preparation of Thermoplastic Resin Composition 3>

Thermoplastic resin composition 3 was prepared in a similar manner to preparation of above-described thermoplastic resin composition 1, except that resin (3) having a refractive index of 1.53 and an Abbe's number of 57, which is described in Table 1, was utilized instead of resin (1).

<Preparation of Thermoplastic Resin Composition 4>

Thermoplastic resin composition 4 was prepared in a similar manner to preparation of above-described thermoplastic resin composition 2, except that the weight ratio of resin (2) to inorganic particles A was changed to 48:52.

<Preparation of Thermoplastic Resin Composition 5>

Thermoplastic resin composition 5 was prepared in a similar manner to preparation of above-described thermoplastic resin composition 2, except that the weight ratio of resin (2) to inorganic particles A was changed to 31:69.

<Preparation of Thermoplastic Resin Composition 6>

Into Mixing Kneader Laboplustomill C Type equipped with a mixer (KF70) and a high shear rotor, resin (2) described in Table 1 and inorganic particles B were charged so as to make a weight ratio of 19:81, and the mixture were mixing kneaded; the mixing kneader emergently stopped due to over load, resulting in no thermoplastic rein composition 6.

<Preparation of Thermoplastic Resin Composition 7>

Thermoplastic resin composition 7 was prepared in a similar manner to preparation of above-described thermoplastic resin composition 2, except that inorganic particles B prepared above were utilized instead of inorganic particles A and the weight ratio of resin (2) to inorganic particles B was changed to 64:36.

<Preparation of Thermoplastic Resin Composition 8>

Thermoplastic resin composition 8 was prepared in a similar manner to preparation of above-described thermoplastic resin composition 7, except that resin (3) was utilized instead of resin (2).

<Preparation of Thermoplastic Resin Composition 9>

Thermoplastic resin composition 9 was prepared in a similar manner to preparation of above-described thermoplastic resin composition 7, except the weight ratio of resin (2) to inorganic particles B was changed to 42:58.

<Preparation of Thermoplastic Resin Composition 10>

Thermoplastic resin composition 10 was prepared in a similar manner to preparation of above-described thermoplastic resin composition 7, except that inorganic particles C was utilized instead of inorganic particles B.

<Preparation of Thermoplastic Resin Composition 11>

Thermoplastic resin composition 11 was prepared in a similar manner to preparation of above-described thermoplastic resin composition 8, except that inorganic particles C prepared above were utilized instead of inorganic particles B.

<Preparation of Thermoplastic Resin Composition 12>

Thermoplastic resin composition 12 was prepared in a similar manner to preparation of above-described thermoplastic resin composition 9, except that inorganic particles C prepared above were utilized instead of inorganic particles B.

<Evaluation of Thermoplastic Resin Composition>

[Evaluation of Refractive Index]

Thermoplastic resin compositions 1-12 each, which were prepared above, were melt and heat molded to prepare a test plate having a thickness of 0.5 mm; and refractive indexes at wavelengths of 588 nm, 486 nm and 656 nm with respect to each sample were measured. The measurement temperature was 23° C. Refractive index n_{d} at 588 nm and Abbe's number vd determined according to aforesaid Formula (4) are shown in Table 2.

[Evaluation of Transparency]

Thermoplastic resin compositions 1-12 each, which were prepared above, were melt and heat molded to prepare a test plate having a thickness of 3 mm. A transmittance in the thickness direction at a wavelength of 588 nm was measured with respect to each test plate by use of spectrophotometer UV-3150 produced by Shimadzu Corp. and the results are shown in Table 2.

TABLE 2

| Thermo- | Inorganic | | | | | Thermoplastic | | | | | |
|---|---|---|---|---|---|---|---|---|---|---|---|
| plastic | particles | | Thermoplastic resin | | | resin composition | | | | | |
| resin | | Volume | Resin | Refractive | | Refractive | Abbe's | | | Trans- | |
| composition | | fraction | No. (In | Index | Abbe's | Index | Number | Formula (1) | Formula (2) | mittance | |
| No. | type | f | Table 1) | n₀ | Number | n_{d} | v_{d} | *1 | *2 | (%) | Remarks |
| 1 | A | 0.1 | Resin (1) | 1.49 | 58 | 1.60 | 57 | 1.58 | 1.52 | 89 | Inv. |
| 2 | A | 0.1 | Resin (2) | 1.54 | 56 | 1.62 | 55 | 1.59 | 1.57 | 90 | Inv. |
| 3 | A | 0.1 | Resin (3) | 1.53 | 57 | 1.61 | 55 | 1.59 | 1.56 | 89 | Inv. |
| 4 | A | 0.2 | Resin (2) | 1.54 | 56 | 1.66 | 53 | 1.60 | 1.60 | 88 | Inv. |
| 5 | A | 0.3 | Resin (2) | 1.54 | 56 | 1.72 | 52 | 1.60 | 1.63 | 86 | Inv. |
| 6 | B | 0.4 | Resin (2) | 1.54 | 56 | not | not | — | — | — | Comp. |
| | | | | | | obtained | obtained | | | | |
| 7 | B | 0.1 | Resin (2) | 1.54 | 56 | 1.56 | 57 | 1.58 | 1.57 | 91 | Comp. |
| 8 | B | 0.1 | Resin (3) | 1.53 | 57 | 1.55 | 56 | 1.58 | 1.56 | 90 | Comp. |
| 9 | B | 0.2 | Resin (2) | 1.54 | 56 | 1.57 | 58 | 1.58 | 1.60 | 90 | Comp. |
| 10 | C | 0.1 | Resin (2) | 1.54 | 56 | 1.63 | 32 | 1.69 | 1.57 | 85 | Comp. |
| 11 | C | 0.1 | Resin (3) | 1.53 | 57 | 1.62 | 33 | 1.68 | 1.56 | 84 | Comp. |
| 12 | C | 0.2 | Resin (2) | 1.54 | 56 | 1.70 | 24 | 1.72 | 1.60 | 78 | Comp. |

*1: 1.82 − 0.0042 v_{d}
*2: n₀ + 0.3 f
Inv.: Inventive
Comp.: Comparative

It is clear from the description of Table 2 that thermoplastic resin compositions of this invention, which satisfy a condition defined by Formula (1) or (2) and (3), are provided with a high refractive index, a high Abbe's number in addition to high transparency, compared to comparative examples.

### Example 2

An optical element made of plastic employing a thermoplastic resin composition of this invention prepared above, was prepared and evaluated to confirm that an optical element of this invention has superior optical characteristics and is excellent in deterioration resistance of a material against such as white turbidity even with a long period of irradiation of Blue-Ray which is utilized for recording and reproduction of CD and DVD.

### POSSIBILITY FOR INDUSTRIAL USE

This invention can provide a thermoplastic resin composition and an optical element utilizing the same, which are provided with a high refractive index and low dispersion (a high Abbe's number) in addition to are excellent in transparency and weight reduction adaptability.

What is claimed is:

1. A thermoplastic resin composition comprising a thermoplastic resin and inorganic particles dispersed in the thermoplastic resin, the thermoplastic resin being melt-moldable, wherein n_{d} and v_{d} of the thermoplastic resin composition satisfy Formula (1), provided that n_{d} represents a refractive index measured at a wavelength of 588 nm and v_{d} represents an Abbe's number:
n_{d}>1.82−0.0042v_{d} Formula (1)

2. The thermoplastic resin composition of claim 1, wherein the Abbe's number v_{d} is 40 to 70.

3. A thermoplastic resin composition comprising a thermoplastic resin having a refractive index n₀ measured at a wavelength of 588 nm and inorganic particles dispersed in the thermoplastic resin, the thermoplastic resin being melt-moldable, wherein f, n_{d} and v_{d} of the thermoplastic resin composition further satisfy Formulas (2) and (3), provided that f represents a volume fraction of the inorganic particles based on the volume of the thermoplastic resin composition, n_{d} represents a refractive index measured at a wavelength of 588 nm and v_{d} represents an Abbe's number:
n_{d}≧n₀+0.3f Formula (2)
v_{d}≧50 Formula (3)

4. The thermoplastic resin composition of claim 3, wherein f is not more than 0.3.

5. The thermoplastic resin composition of claim 3, wherein n_{d} measured at a wavelength of 588 nm is not less than 1.6.

6. The thermoplastic resin composition of claim 1, wherein the inorganic particles comprise at least aluminum nitride.

7. A thermoplastic resin composition comprising a thermoplastic resin and inorganic particles dispersed in the thermoplastic resin, the thermoplastic resin being melt-moldable, wherein, the inorganic particles comprise at least a metal nitride.

8. The thermoplastic resin composition of claim 7, wherein the metal nitride is aluminum nitride.

9. An optical element formed by molding the thermoplastic resin composition of claim 1, wherein a mean light transmittance measured at a wavelength of 588 nm per a light path length of 3 mm is not less than 70%.

10. The thermoplastic resin composition of claim 3, wherein the inorganic particles comprise at least aluminum nitride.

11. An optical element formed by molding the thermoplastic resin composition of claim 3, wherein a mean light transmittance measured at a wavelength of 588 nm per a light path length of 3 mm is not less than 70%.

12. An optical element formed by molding the thermoplastic resin composition of claim 7, wherein a mean light transmittance measured at a wavelength of 588 nm per a light path length of 3 mm is not less than 70%.
